(19) United States
(12) Patent Application Publication
(10) Pub. No.: US 2020/0131314 A1
(43) Pub. Date: Apr. 30, 2020

(54) RESIN COMPOSITION, LAMINATE AND MANUFACTURING METHOD THEREOF, ELECTRODE, SECONDARY BATTERY, AND ELECTRIC DOUBLE LAYER CAPACITOR

(71) Applicant: TORAY Industries, Inc., Tokyo (JP)

(72) Inventors: Natsuko CHAYAMA, Otsu-shi (JP); Tomoyuki YUBA, Otsu-shi (JP)

(73) Assignee: TORAY Industries, Inc., Tokyo (JP)

(21) Appl. No.: 16/624,691

(22) PCT Filed: Jun. 26, 2018
(86) PCT No.: PCT/JP2018/024115

§ 371 Date: Dec. 19, 2019

(30) Foreign Application Priority Data
Jul. 7, 2017 (JP) 2017-133334
Apr. 17, 2018 (JP) 2018-078909

(51) Int. Cl. C08G 73/14; C08G 73/22; C08K 3/013; C08K 3/22; C08K 3/36; C08J 5/18; H01G 11/30; C08K 3/08; H01M 4/62

(52) U.S. Cl. CPC C08G 73/14; C08G 73/22; C08K 3/013; C08K 3/22; C08K 3/36; C08K 2003/0818; H01G 11/30; C08K 3/08; H01M 4/622; C08K 2003/2203; C08J 5/18

(57) ABSTRACT

An object of the present invention is to provide a resin composition containing: (a) a resin containing at least one of a polyimide, a polyamideimide, and a polybenzoxazole, having at least one acidic functional group among a phenolic hydroxyl group, a carboxyl group, and a sulfonic acid group in a side chain, and having an acidic functional group concentration of 3.4 mol/kg or more; and (b) a basic compound. The resin composition has high long-term stability in the form of an aqueous solution while having high strength and high modulus, has good dispersibility of a filler, and has a good binding property as a binder.

### TECHNICAL FIELD

The present invention relates to a resin composition, a laminate and a method for manufacturing the same, an electrode, a secondary battery, and an electric double layer capacitor.

### BACKGROUND ART

Lithium-ion batteries as rechargeable high-capacity batteries have enabled higher functionality and long-time operation of electronic devices. Moreover, lithium-ion batteries are mounted on automobiles and the like, and are regarded as promising as batteries for hybrid cars and electric cars.

Lithium-ion batteries widely used today have, as a cathode, a product formed by applying a slurry containing an active material such as lithium cobalt oxide and a binder such as polyvinylidene fluoride (PVDF) to an aluminum foil piece. The lithium-ion batteries have, as an anode, a product formed by applying a slurry containing a carbon-based active material and a binder such as PVDF or styrene-butadiene rubber (SBR) to a copper foil piece.

In order to further increase the capacity of lithium-ion batteries, use of silicon, germanium, or tin as an anode active material has been studied (see, for example, Patent Document 1). Since an anode active material containing silicon, germanium, tin, or the like can receive a large amount of lithium ions, the anode active material undergoes a large volume change between when fully charged and when fully discharged. Meanwhile, binders such as PVDF and SBR described above cannot follow the volume change of the active material.

In view of the above, studies have been made on the use of a polyimide resin having higher strength and higher modulus as a binder for the anode (see, for example, Patent Document 2). However, polyimide resins generally have a problem that they are only soluble in organic solvents such as N-methylpyrrolidone and N,N′-dimethylacetamide and have a high environmental load. For this reason, studies have been made on the use of an aqueous binder obtained by admixing a resin with an aqueous solvent.

As for an aqueous solution of a polyimide resin, there have been known an aqueous solution of a polyimide precursor to which a water-soluble organic amine or an imidazole compound is added (see, for example, Patent Documents 3 and 4), and an aqueous solution that is a mixture of a polyimide having a side chain in which a hydroxyl group, a carboxyl group, or a sulfonic acid group is introduced and an alkali metal hydroxide or the like (see, for example, Patent Document 5 and Non-Patent Document 1).

### PRIOR ART DOCUMENTS

### Non-Patent Document

Non-Patent Document 1: Macromol Symposia, 1996, 106, pp. 345-351

### Patent Documents

Patent Document 1: Japanese Patent Laid-open Publication No. 2009-199761
Patent Document 2: Japanese Patent Laid-open Publication No. 2009-245773
Patent Document 3: Japanese Patent Laid-open Publication No. 8-3445
Patent Document 4: Japanese Patent Laid-open Publication No. 2002-226582
Patent Document 5: Japanese Patent Laid-open Publication No. 2011-137063

### SUMMARY OF THE INVENTION

### Problems to be Solved by the Invention

However, the aqueous solution of a polyimide precursor as described in Patent Documents 3 and 4 has a problem that the polymer main chain is hydrolyzed to deteriorate the aqueous solution. In addition, the aqueous solution of a polyimide resin as described in Patent Document 5 and Non-Patent Document 1 has a problem that the aqueous solution is insufficient in long-term stability because the resin is low in solubility in water. The aqueous solution also has a problem of scarce interaction between the ionized side chain and the filler, so that a slurry obtained from the aqueous solution cannot provide sufficient dispersibility of the filler and a sufficient binding property as a binder.

In view of the above-mentioned problems, an object of the present invention is to provide a resin composition having high long-term stability in the form of an aqueous solution while having high strength and high modulus, having good dispersibility of a filler, and having a good binding property as a binder.

### Solutions to the Problems

The present invention provides a resin composition containing: (a) a resin containing at least one of a polyimide, a polyamideimide, and a polybenzoxazole, having at least one acidic functional group among a phenolic hydroxyl group, a carboxyl group, and a sulfonic acid group in a side chain, and having an acidic functional group concentration of 3.4 mol/kg or more; and (b) a basic compound.

### Effects of the Invention

According to the present invention, it is possible to provide a resin composition having high long-term stability in the form of an aqueous solution while having high strength and high modulus, having good dispersibility of a filler, and having a good binding property as a binder.

### EMBODIMENTS OF THE INVENTION

Hereinafter, preferable embodiments of the resin composition, the laminate and the method for manufacturing the same, the electrode, the secondary battery, and the electric double layer capacitor according to the present invention will be described in detail. Note that the present invention is not limited by these embodiments.

<Resin Composition>

The resin composition according to an embodiment of the present invention is a resin composition containing: (a) a resin containing at least one of a polyimide, a polyamideimide, and a polybenzoxazole, having at least one acidic functional group among a phenolic hydroxyl group, a carboxyl group, and a sulfonic acid group in a side chain, and having an acidic functional group concentration of 3.4 mol/kg or more; and (b) a basic compound.

((a) Resin)

The resin (a) containing at least one of a polyimide, a polyamideimide, and a polybenzoxazole has at least one acidic functional group among a phenolic hydroxyl group, a carboxyl group, and a sulfonic acid group in a side chain. The resin (a) is excellent in solubility in water because the resin (a) has an acidic functional group in a side chain.

It is preferable that the resin (a) contain a repeating unit structure including at least one of a phenolic hydroxyl group, a carboxyl group, and a sulfonic acid group in a side chain in an amount of 50 mol % or more of all the repeating units for further improving the solubility in water. The content of the repeating unit structure in the resin (a) is more preferably 70 mol % or more, still more preferably 90 mol % or more.

A polyimide is a polymer obtained by reacting a diamine with a tetracarboxylic acid or a derivative thereof, for example. It is preferable that a diamine residue in a polyimide have at least one of a phenolic hydroxyl group, a carboxyl group, and a sulfonic acid group.

A polyamideimide is a polymer obtained by reacting a diamine with a tricarboxylic acid or a derivative thereof, for example. It is preferable that a diamine residue in a polyamideimide have at least one of a phenolic hydroxyl group, a carboxyl group, and a sulfonic acid group.

A polybenzoxazole is a polymer obtained by reacting a diamine having a hydroxyl group with a dicarboxylic acid or a derivative thereof, for example. It is preferable that a dicarboxylic acid residue in a polybenzoxazole have at least one of a phenolic hydroxyl group, a carboxyl group, and a sulfonic acid group.

Preferable specific examples of the diamine include diamines having a hydroxyl group, such as bis(3-amino-4-hydroxyphenyl) hexafluoropropane, bis(3-amino-4-hydroxyphenyl)sulfone, bis(3-amino-4-hydroxyphenyl)propane, bis(3-amino-4-hydroxyphenyl)methylene, bis(3-amino-4-hydroxyphenyl)ether, bis(3-amino-4-hydroxy)biphenyl, bis(3-amino-4-hydroxyphenyl)fluorene, bis(4-amino-3-hydroxyphenyl)hexafluoropropane, bis(4-amino-3-hydroxyphenyl)sulfone, bis(4-amino-3-hydroxyphenyl)propane, bis(4-amino-3-hydroxyphenyl)methylene, bis(4-amino-3-hydroxyphenyl)ether, bis(4-amino-3-hydroxy)biphenyl, and bis(4-amino-3-hydroxyphenyl)fluorene, carboxyl group-containing diamines, such as 3-carboxy-4,4′-diaminodiphenyl ether, 3,5-diaminobenzoic acid, 3,4-diaminobenzoic acid, 3,3′-dicarboxy-4,4′-diaminodiphenylmethane, 4,4′-dicarboxy-3,3′-diaminodiphenylmethane, bis(3-amino-4-carboxyphenyl)sulfone, 2,2-bis(3-amino-4-carboxyphenyl)propane, 2,2-bis(3-amino-5-carboxyphenyl)propane, 2,2-bis(4-amino-3-carboxyphenyl)propane, 2,2-bis(3-amino-4-carboxyphenyl)hexafluoropropane, 2,2-bis(3-amino-5-carboxyphenyl)hexafluoropropane, 2,2-bis(4-amino-3-carboxyphenyl)hexafluoropropane, and bis(3-amino-4-carboxyphenyl)ether, sulfonic acid-containing diamines, such as 3-sulfonic acid-4,4′-diaminodiphenyl ether, and compounds containing a hydrogenated aromatic ring of the diamine.

In addition, a diamine other than the diamine having at least one of a phenolic hydroxyl group, a carboxyl group, and a sulfonic acid group (the diamine is referred to as “different diamine”) may be used as a copolymer component as long as the long-term stability of the aqueous solution is not impaired. Preferable specific examples of the different diamine include 3,4′-diaminodiphenyl ether, 4,4′-diaminodiphenyl ether, 3,3′-diaminodiphenyl ether, 3,4′-diaminodiphenylmethane, 4,4′-diaminodiphenylmethane, 3,3′-diaminodiphenylmethane, 3,4′-diaminodiphenylsulfone, 4,4′-diaminodiphenylsulfone, 3,3′-diaminodiphenylsulfone, 3,4′-diaminodiphenylsulfide, 4,4′-diaminodiphenylsulfide, 3,3′-diaminodiphenylsulfide, 1,4-bis(4-aminophenoxy)benzene, m-phenylenediamine, p-phenylenediamine, 1,5-naphthalenediamine, 2,6-naphthalenediamine, bis[4-(4-aminophenoxy)phenyl]sulfone, bis[4-(3-aminophenoxy)phenyl]sulfone, 4,4′-bis(4-aminophenoxy)biphenyl, bis[4-(4-aminophenoxy)phenyl]ether, 2,2′-dimethyl-4,4′-diaminobiphenyl, 2,2′-diethyl-4,4′-diaminobiphenyl, 3,3′-dimethyl-4,4′-diaminobiphenyl, 3,3′-diethyl-4,4′-diaminobiphenyl, 2,2′,3,3′-tetramethyl-4,4′-diaminobiphenyl, 3,3′,5,5′-tetramethyl-4,4′-diaminobiphenyl, 2,2′-di(trifluoromethyl)-4,4′-diaminobiphenyl, and compounds containing a hydrogenated aromatic ring of the diamine.

When the resin (a) is a polybenzoxazole, any of the above-mentioned diamines having a hydroxyl group is preferably used.

Preferable specific examples of the tetracarboxylic acid or a derivative thereof include aromatic tetracarboxylic acids such as pyromellitic acid, 3,3′,4,4′-biphenyltetracarboxylic acid, 2,3,3′,4′-biphenyltetracarboxylic acid, 2,2′,3,3′-biphenyltetracarboxylic acid, 3,3′,4,4′-benzophenonetetracarboxylic acid, 2,2′,3,3′-benzophenonetetracarboxylic acid, 2,2-bis(3,4-dicarboxyphenyl)hexafluoropropane, 2,2-bis(2,3-dicarboxyphenyl)hexafluoropropane, 1,1-bis(3,4-dicarboxyphenyl)ethane, 1,1-bis(2,3-dicarboxyphenyl)ethane, bis(3,4-dicarboxyphenyl)methane, bis(2,3-dicarboxyphenyl)methane, bis(3,4-dicarboxyphenyl)sulfone, bis(3,4-dicarboxyphenyl)ether, 1,2,5,6-naphthalenetetracarboxylic acid, 2,3,6,7-naphthalenetetracarboxylic acid, 2,3,5,6-pyridinetetracarboxylic acid, and 3,4,9,10-perylenetetracarboxylic acid, aliphatic tetracarboxylic acids such as 1,2,3,4-cyclobutanetetracarboxylic acid, 1,2,3,4-cyclopentanetetracarboxylic acid, cyclohexanetetracarboxylic acid, bicyclo[2.2.1.]heptanetetracarboxylic acid, bicyclo[3.3.1.]tetracarboxylic acid, bicyclo[3.1.1.]hept-2-ene-tetracarboxylic acid, bicyclo[2.2.2.]octanetetracarboxylic acid, adamantanetetracarboxylic acid, bicyclo[2,2,2]oct-7-ene-2,3,5,6-tetracarboxylic acid, meso-butane-1,2,3,4-tetracarboxylic acid, and 1,2,3,4-butanetetracarboxylic acid, dianhydrides of these tetracarboxylic acids, or 1,3,3a,4,5,9b-hexahydro-5-(tetrahydro-2,5-dioxo-3-furanyl)naphtho[1,2-c]furan-1,3-dione, and 3-(carboxymethyl)-1,2,4-cyclopentanetricarboxylic acid 1,4:2,3-dianhydride.

Preferable specific examples of the tricarboxylic acid or a derivative thereof include trimellitic acid, trimesic acid, diphenyl ether tricarboxylic acid, biphenyltricarboxylic acid, and anhydrides of these tricarboxylic acids.

Preferable specific examples of the dicarboxylic acid or a derivative thereof include dicarboxylic acids having a hydroxyl group, such as 3,5-dicarboxyphenol, 2,4-dicarboxyphenol, and 2,5-dicarboxyphenol, and dicarboxylic acids having a sulfonic acid group, such as 3,5-dicarboxybenzenesulfonic acid, 2,4-dicarboxybenzenesulfonic acid, and 2,5-dicarboxybenzenesulfonic acid.

In addition, a dicarboxylic acid other than the dicarboxylic acid having at least one of a phenolic hydroxyl group, a carboxyl group, and a sulfonic acid group (the dicarboxylic acid is referred to as “different dicarboxylic acid”) may be used as a copolymer component as long as the long-term stability of the aqueous solution is not impaired. Preferable specific examples of the different dicarboxylic acid include terephthalic acid, isophthalic acid, diphenyl ether dicarboxylic acid, diphenylsulfone dicarboxylic acid, diphenylmethane dicarboxylic acid, biphenyldicarboxylic acid, 2,2′-bis(carboxyphenyl)propane, and 2,2′-bis(carboxyphenyl)hexafluoropropane.

Further, the resin (a) may be used as a mixture with a resin other than a polyimide, a polyamideimide, and a polybenzoxazole (the resin is referred to as “different resin”). Preferable specific examples of the different resin include an acrylic resin, a methacrylic resin, a vinyl resin, a phenol resin, and a cellulose resin. Particularly preferable examples of the different resin include polyvinyl alcohol, polyvinyl pyrrolidone, and carboxymethyl cellulose.

In this case, from the viewpoint of strength and modulus of the resin composition, the content of the resin (a) is preferably 80 mass % or more, more preferably 85 mol % or more, still more preferably 90 mol % or more, most preferably 95 mol % or more of the whole resins.

The concentration of acidic functional groups in the resin (a) is 3.4 mol/kg or more, preferably 3.5 mol/kg or more, more preferably 4.0 mol/kg or more, most preferably 4.3 mol/kg or more. Increasing the concentration of acidic functional groups in the resin (a) improves the long-term stability of the aqueous solution. Moreover, when the resin composition contains the filler described later, the interaction between the resin and the filler is increased, and the dispersibility of the filler in the resin composition and the binding property as a binder are improved. Accordingly, a coating film formed from the resin composition has improved thickness uniformity and chemical resistance. The upper limit of the concentration of acidic functional groups in the resin (a) is not particularly limited, but is preferably 6.0 mol/kg or less.

The concentration of acidic functional groups herein is the number of moles of acidic functional groups contained per 1 kg of the resin (a), and is calculated as follows. The number of acidic functional groups in a repeating unit in the resin (a) is defined as A (groups), and the molecular weight of the repeating unit is defined as B.

As for A and B, for example, in the case of the following repeating unit, A=2 and B=548.

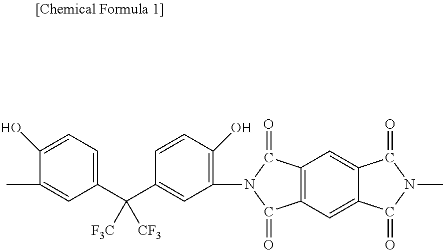

In the case of the following repeating unit, A=2 and B=851.

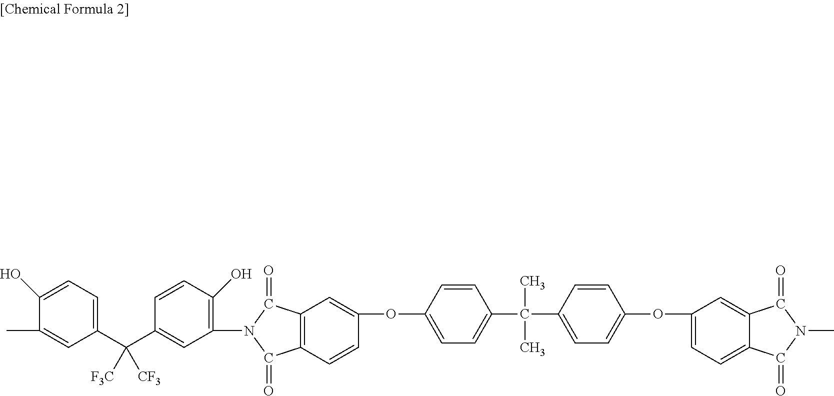

The functional group concentration is calculated from A/B×1000.

When the resin (a) is a copolymer having a plurality of repeating units, the functional group concentration in the resin (a) is the sum of products of the functional group concentrations and the molar ratios of the repeating units. For example, when n/(n+m)=0.7 in the following structure, A=2×0.7=1.4 and B=548×0.7+382×0.3=498, and the functional group concentration is 1.4/498×1000=2.81.

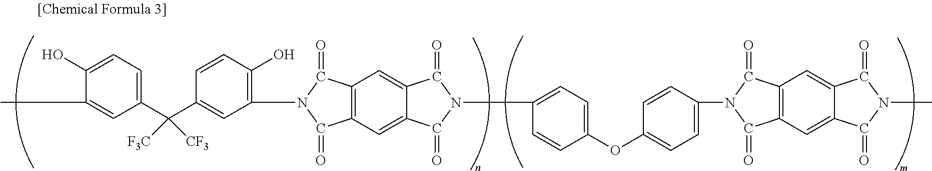

Furthermore, from the viewpoint that the long-term stability of the aqueous solution is further improved, and that when the resin composition contains the filler described later, the interaction between the resin and the filler is further increased, and the dispersibility of the filler in the resin composition and the binding property as a binder are further improved, the resin (a) preferably contains a structure represented by a general formula (1) shown below as a repeating unit.

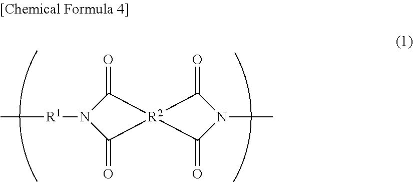

In the general formula (1), R¹ represents a divalent organic group having 2 to 50 carbon atoms, and includes at least one of a phenolic hydroxyl group, a carboxyl group, and a sulfonic acid group. R² represents a trivalent or tetravalent organic group having 2 to 50 carbon atoms.

The resin containing the structure represented by the general formula (1) as a repeating unit can be obtained, for example, by reacting a diamine including at least one of a phenolic hydroxyl group, a carboxyl group, and a sulfonic acid group in the structure with a tetracarboxylic acid or a derivative thereof.

From the viewpoint that when the resin composition contains the filler described later, the interaction between the resin and the filler is further increased, and the dispersibility of the filler in the resin composition and the binding property as a binder are further improved, the content of the resin containing the structure represented by the general formula (1) as a repeating unit is preferably 60 mol % or more, more preferably 80 mol % or more, still more preferably 90 mol % or more, most preferably 95 mol % or more of the whole resins in the resin (a).

The content of the structural unit represented by the general formula (1) in the resin can be estimated by the following methods. One method is a method of analyzing the resin by infrared spectroscopy (FT-IR), nuclear magnetic resonance (NMR), thermogravimetry-mass spectrometry (TG-MS), time-of-flight secondary ion mass spectrometry (TOF-SIMS), or the like. Another method is a method of decomposing the resin into constituent components, and then analyzing the components by gas chromatography (GC), high performance liquid chromatography (HPLC), mass spectrometry (MS), FT-IR, NMR, or the like. Yet another method is a method of ashing the resin at a high temperature, and then analyzing the resin by elemental analysis or the like.

In particular, in the present invention, the resin is decomposed into constituent components, and then the components are analyzed by a combination of high performance liquid chromatography (HPLC) and mass spectrometry (MS).

(Diamine Residue)

In the general formula (1), R¹ represents a diamine residue including at least one of a phenolic hydroxyl group, a carboxyl group, and a sulfonic acid group in the structure. Specific examples of a preferable diamine that provides the diamine residue are as described above.

From the viewpoint of long-term stability of the aqueous solution, it is preferable that the resin composition contain, in the total number of the structures represented by the general formula (1) contained in the resin (a), 20 mol % or more of a structure in which R¹ has an aromatic skeleton. Specifically, it is preferable that 20 mol % or more of R¹ in the resin (a) be aromatic diamine residues. The content of the aromatic diamine residues is more preferably 50 mol % or more, still more preferably 70 mol % or more, most preferably 90 mol % or more.

Further, from the viewpoint of long-term stability of the aqueous solution, R¹ is more preferably at least one of general formulae (2) and (3) shown below.

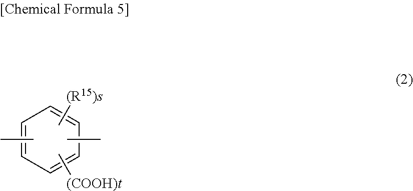

R¹⁵ represents a halogen atom or a monovalent organic group having 1 to 8 carbon atoms. s represents an integer of 0 to 3. t represents an integer of 1 or 2.

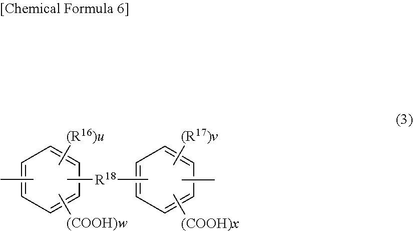

R¹⁶ and R¹⁷ each independently represent a halogen atom or a monovalent organic group having 1 to 8 carbon atoms. u and v each independently represent an integer of 0 to 3. w and x each independently represent an integer of 1 or 2. R¹⁸ is a single bond, O, S, NH, SO₂, CO, or a divalent organic group having 1 to 3 carbon atoms.

Preferable specific examples of the divalent organic group having 1 to 3 carbon atoms include saturated hydrocarbon groups having 1 to 3 carbon atoms.

From the viewpoint that when the resin composition contains the filler described later, the interaction between the resin and the filler is further increased, and the dispersibility of the filler in the resin composition and the binding property as a binder are further improved, s is preferably 0.

From the viewpoint that when the resin composition contains the filler described later, the interaction between the resin and the filler is further increased, and the dispersibility of the filler in the resin composition and the binding property as a binder are further improved, u and v are preferably each 0.

Examples of the diamine that provides the diamine residue represented by the general formula (2) or (3) include 3,5-diaminobenzoic acid, 3,4-diaminobenzoic acid, 3,3′-dicarboxy-4,4′-diaminodiphenylmethane, 4,4′-dicarboxy-3,3′-diaminodiphenylmethane, bis(3-amino-5-carboxyphenyl)methane, bis(3-amino-4-carboxyphenyl)sulfone, 2,2-bis(3-amino-4-carboxyphenyl)propane, 2,2-bis(3-amino-5-carboxyphenyl)propane, 2,2-bis(4-amino-3-carboxyphenyl)propane, 2,2-bis(3-amino-4-carboxyphenyl)hexafluoropropane, 2,2-bis(3-amino-5-carboxyphenyl)hexafluoropropane, 2,2-bis(4-amino-3-carboxyphenyl)hexafluoropropane, and bis(3-amino-4-carboxyphenyl)ether.

In addition, the above-mentioned structure may include a residue of the above-mentioned different diamine as long as the long-term stability of the aqueous solution is not impaired. A preferable content of the residue of the different diamine is 40 mol % or less, more preferably 30 mol % or less, still more preferably 25 mol % or less, most preferably 10 mol % or less in R¹ in the resin (a).

When the composition contains the filler described later, the interaction between the resin and the filler is increased, and the dispersibility of the filler in the resin composition and the chemical resistance are improved. From this viewpoint, it is particularly preferable that 1 to 25 mol % of R¹ be at least one of general formulae (4) and (5) shown below.

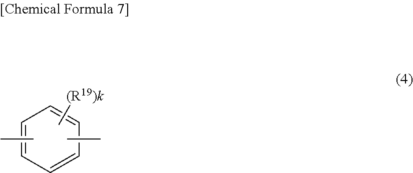

R¹⁹ represents a halogen atom or a monovalent organic group having 1 to 8 carbon atoms. k represents an integer of 0 to 4.

From the viewpoint that when the resin composition contains the filler described later, the interaction between the resin and the filler is further increased, and the dispersibility of the filler in the resin composition and the binding property as a binder are further improved, k is preferably 0.

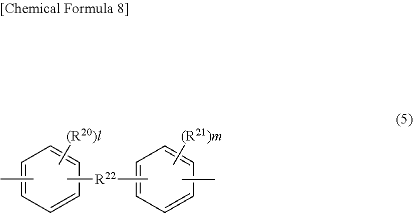

R²⁰ and R²¹ each independently represent a halogen atom or a monovalent organic group having 1 to 8 carbon atoms. 1 and m each independently represent an integer of 0 to 4. R²² is a single bond, O, S, NH, SO₂, CO, or a divalent organic group having 1 to 3 carbon atoms.

Preferable specific examples of the divalent organic group having 1 to 3 carbon atoms include saturated hydrocarbon groups having 1 to 3 carbon atoms.

From the viewpoint that when the resin composition contains the filler described later, the interaction between the resin and the filler is further increased, and the dispersibility of the filler in the resin composition and the binding property as a binder are further improved, l and m are preferably each 0.

Usable raw materials that provide these diamine residues include, in addition to the diamines, diisocyanate compounds in which an isocyanate group instead of an amino group is bonded to the structure of a diamine residue, and tetratrimethylsilylated diamines in which two hydrogen atoms of an amino group of a diamine are substituted with trimethylsilyl groups.

Further, in order to improve the adhesion to the base material, it is acceptable that 1 to 10 mol % of R¹ in the resin (a) be a diamine residue including a siloxane bond. Specific examples of the diamine that provides a diamine residue including a siloxane bond include 1,3-bis(3-aminopropyl)tetramethyldisiloxane.

From the viewpoint that when the composition contains the filler described later, the interaction between the resin and the filler is increased, and the dispersibility of the filler in the resin composition and the thickness uniformity of a film produced from the resin composition are improved, it is preferable that 0.1 to 10 mol % of R¹ be a general formula (6) shown below.

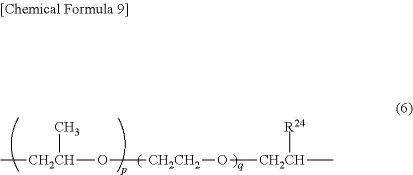

R²⁴ represents a hydrogen atom or a methyl group. p and q each independently represent an integer of 0 or more, and 1<p+q<20.

From the viewpoint that when the resin composition contains the filler described later, the interaction between the resin and the filler is further increased, and the dispersibility of the filler in the resin composition and the binding property as a binder are further improved, it is more preferable that R²⁴ be a hydrogen atom and p=0, and it is still more preferable that 1<q<4.

(Acid Residue)

In the general formula (1), R² represents a tetracarboxylic acid residue (hereinafter referred to as “acid residue”). Examples of a preferable tetracarboxylic acid or a derivative thereof that provides an acid residue are as described above.

Further, it is also possible to use a carboxylic acid residue which is derived from the above-exemplified tetracarboxylic acids and in which 1 to 4 hydrogen atoms are substituted with a hydroxyl group, an amino group, a sulfonic acid group, a sulfonic acid amide group, or a sulfonic acid ester group.

The acid residue is preferably at least one residue selected from structures shown below. That is, R² is preferably at least one structure selected from structures shown below. Of these, a residue having an aliphatic structure is more preferable.

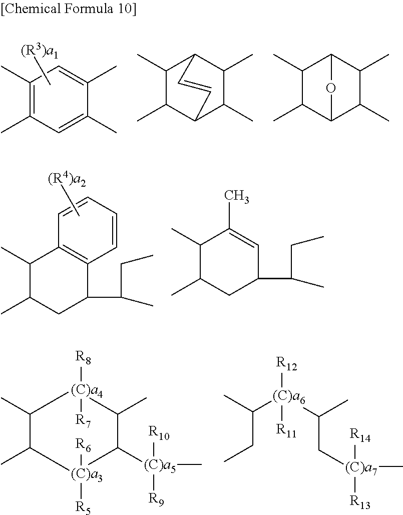

R³ and R⁴ each independently represent a halogen atom or an organic group having 1 to 6 carbon atoms. R⁵ to R¹⁴ each independently represent a hydrogen atom, a halogen atom, or an organic group having 1 to 6 carbon atoms. a₁ is an integer of 0 to 2. a₂ is an integer of 0 to 4. a₃ and a₄ are each independently an integer of 0 to 4, and a₃+a₄<5. a₆ is an integer of 0 to 6. a₅ and a₇ are each independently an integer of 0 to 2.

Preferable specific examples of R³ and R⁴ include a chlorine atom, a fluorine atom, a saturated hydrocarbon group having 1 to 4 carbon atoms, a cyclic saturated hydrocarbon group having 4 to 6 carbon atoms, and a trifluoromethyl group.

Preferable specific examples of R⁵ to R¹⁴ include a hydrogen atom, a chlorine atom, a fluorine atom, a saturated hydrocarbon group having 1 to 4 carbon atoms, a cyclic saturated hydrocarbon group having 4 to 6 carbon atoms, and a trifluoromethyl group. From the viewpoint that when the resin composition contains the filler described later, the interaction between the resin and the filler is further increased, and the dispersibility of the filler in the resin composition and the binding property as a binder are further improved, R⁵ to R¹⁴ are more preferably each a hydrogen atom.

From the same viewpoint, a₁ and a₂ are preferably each 0, a₃+a₄<2 is preferably satisfied, a₆ is preferably 0 to 2, more preferably 0, and a₅ and a₇ are preferably each 0 to 1, more preferably each 0.

Use of these acid residues improves the long-term stability of the aqueous solution. Moreover, when the resin composition contains the filler described later, the use increases the interaction between the resin and the filler, and improves the dispersibility of the filler in the resin composition. Accordingly, a film formed from the resin composition has improved thickness uniformity and chemical resistance.

The most preferable acid residue for obtaining the above-mentioned effect has a structure shown below.

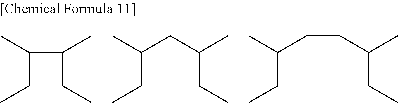

Moreover, it is also possible to use a carboxyl compound having a siloxane bond, such as 1,3-bis(p-carboxyphenyl)-1,1,3,3-tetramethyldisiloxane, 1-(p-carboxyphenyl)-3-phthalic acid-1,1,3,3-tetramethyldisiloxane, and 1,3-bisphthalic acid-1,1,3,3-tetramethyldisiloxane as required. When the resin composition contains an acid residue derived from a carboxyl compound having a siloxane bond, it is possible to improve the adhesive property of a film produced from the resin composition to a substrate.

(End Capping Agent)

From the viewpoint of stability of the aqueous solution and the dispersibility of the filler, it is preferable that the resin containing the structure represented by the general formula (1) as a repeating unit have a terminal structure including at least one structure selected from structures represented by general formulae (7), (8), and (9) shown below.

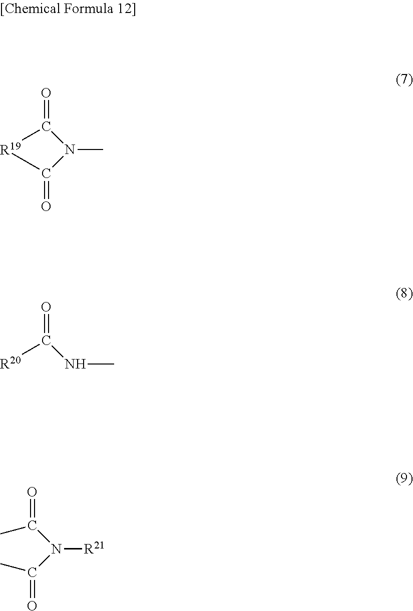

R²⁵, R²⁶, and R²⁷ each independently represent a monovalent organic group having 4 to 30 carbon atoms, and include at least one of a phenolic hydroxyl group, a carboxyl group, and a sulfonic acid group.

These structures can be introduced by capping an end of the resin with an end capping agent such as an acid anhydride, a monocarboxylic acid, and a monoamine compound.

In the general formula (4), ²⁵ represents an acid anhydride residue. Specific examples of the acid anhydride include 3-hydroxyphthalic anhydride.

In the general formula (5), R²⁶ represents a monocarboxylic acid residue. Specific examples of the monocarboxylic acid include 2-carboxyphenol, 3-carboxyphenol, 4-carboxyphenol, 2-carboxythiophenol, 3-carboxythiophenol, 4-carboxythiophenol, 1-hydroxy-8-carboxynaphthalene, 1-hydroxy-7-carboxynaphthalene, 1-hydroxy-6-carboxynaphthalene, 1-hydroxy-5-carboxynaphthalene, 1-hydroxy-4-carboxynaphthalene, 1-hydroxy-3-carboxynaphthalene, 1-hydroxy-2-carboxynaphthalene, 1-mercapto-8-carboxynaphthalene, 1-mercapto-7-carboxynaphthalene, 1-mercapto-6-carboxynaphthalene, 1-mercapto-5-carboxynaphthalene, 1-mercapto-4-carboxynaphthalene, 1-mercapto-3-carboxynaphthalene, 1-mercapto-2-carboxynaphthalene, 2-carboxybenzenesulfonic acid, 3-carboxybenzenesulfonic acid, and 4-carboxybenzenesulfonic acid.

In the general formula (6), R²⁷ represents a monoamine residue. Specific examples of the monoamine include 3-amino-4,6-dihydroxypyrimidine, 2-aminophenol, 3-aminophenol, 4-aminophenol, 5-amino-8-hydroxyquinoline, 4-amino-8-hydroxyquinoline, 1-hydroxy-8-aminonaphthalene, 1-hydroxy-7-aminonaphthalene, 1-hydroxy-6-aminonaphthalene, 1-hydroxy-5-aminonaphthalene, 1-hydroxy-4-aminonaphthalene, 1-hydroxy-3-aminonaphthalene, 1-hydroxy-2-aminonaphthalene, 1-amino-7-hydroxynaphthalene, 2-hydroxy-7-aminonaphthalene, 2-hydroxy-6-aminonaphthalene, 2-hydroxy-5-aminonaphthalene, 2-hydroxy-4-aminonaphthalene, 2-hydroxy-3-aminonaphthalene, 1-amino-2-hydroxynaphthalene, 1-carboxy-8-aminonaphthalene, 1-carboxy-7-aminonaphthalene, 1-carboxy-6-aminonaphthalene, 1-carboxy-5-aminonaphthalene, 1-carboxy-4-aminonaphthalene, 1-carboxy-3-aminonaphthalene, 1-carboxy-2-aminonaphthalene, 1-amino-7-carboxynaphthalene, 2-carboxy-7-aminonaphthalene, 2-carboxy-6-aminonaphthalene, 2-carboxy-5-aminonaphthalene, 2-carboxy-4-aminonaphthalene, 2-carboxy-3-aminonaphthalene, 1-amino-2-carboxynaphthalene, 2-aminonicotinic acid, 4-aminonicotinic acid, 5-aminonicotinic acid, 6-aminonicotinic acid, 4-aminosalicylic acid, 5-aminosalicylic acid, 6-aminosalicylic acid, 3-amino-o-toluic acid, amelide, 2-aminobenzoic acid, 3-aminobenzoic acid, 4-aminobenzoic acid, 2-aminobenzenesulfonic acid, 3-aminobenzenesulfonic acid, 4-aminobenzenesulfonic acid, 5-amino-8-mercaptoquinoline, 4-amino-8-mercaptoquinoline, 1-mercapto-8-aminonaphthalene, 1-mercapto-7-aminonaphthalene, 1-mercapto-6-aminonaphthalene, 1-mercapto-5-aminonaphthalene, 1-mercapto-4-aminonaphthalene, 1-mercapto-3-aminonaphthalene, 1-mercapto-2-aminonaphthalene, 1-amino-7-mercaptonaphthalene, 2-mercapto-7-aminonaphthalene, 2-mercapto-6-aminonaphthalene, 2-mercapto-5-aminonaphthalene, 2-mercapto-4-aminonaphthalene, 2-mercapto-3-aminonaphthalene, 1-amino-2-mercaptonaphthalene, 3-amino-4,6-dimercaptopyrimidine, 2-aminothiophenol, 3-aminothiophenol, and 4-aminothiophenol.

These end capping agents such as acid anhydrides, monocarboxylic acids, and monoamine compounds can be used alone or in combination of two or more of them. Moreover, end capping agents other than these may be used in combination.

The content of the above-mentioned end capping agent in the resin (a) is preferably in the range of 0.1 to 60 mol %, more preferably in the range of 5 to 50 mol % of the number of moles of the charged component monomers that constitute the carboxylic acid residue and the amine residue. When the content is set in the above-mentioned range, the solution has an appropriate viscosity at the time of application, and a resin composition having excellent film properties can be obtained.

Similarly to the case of general polycondensation, the closer the charge ratio (molar ratio) of the diamine to the acid is to 1:1, the greater the degree of polymerization of the produced polymer is, and the higher the weight average molecular weight of the polymer is. In the present invention, the weight average molecular weight of the resin (a) is preferably 10,000 or more and 150,000 or less. The weight average molecular weight is a value measured by GPC (gel permeation chromatography) and is determined by polystyrene conversion. Measurement conditions for the GPC are shown below.

1) Apparatus: Waters 2690

2) Columns: TOSOH CORPORATION, TSK-GEL (d-4000 and d-2500)

3) Solvent: NMP

4) Flow rate: 0.4 mL/min

5) Sample concentration: 0.05 to 0.1 wt %

6) Injection volume: 50 μL

7) Temperature: 40° C.

8) Detector: Waters 996

The polystyrene used for the conversion is the standard polystyrene manufactured by Polymer Laboratories Ltd.

When the resin (a) has a weight average molecular weight of 10,000 or more, a binding property sufficient for a binder can be imparted to the resin composition. On the other hand, when the resin (a) has a weight average molecular weight of 150,000 or less, high solubility in a solvent can be maintained. In order to obtain a polymer having a weight average molecular weight in the above-mentioned range, the charge ratio (molar ratio) of the diamine to the acid is preferably 100:50 to 150.

The solvent used in the polycondensation is not particularly limited as long as the produced resin is soluble in the solvent. It is preferable to use an aprotic polar solvent such as N-methyl-2-pyrrolidone, N-methylcaprolactam, N,N-dimethylacetamide, N,N-dimethylformamide, dimethyl sulfoxide, γ-butyrolactone, and dimethylimidazoline, a phenolic solvent such as phenol, m-cresol, chlorophenol, and nitrophenol, a phosphorus solvent such as polyphosphoric acid and a solvent obtained by adding phosphorous pentoxide to phosphoric acid, or the like.

In general, a polyimide polymer is obtained by reacting an acid anhydride or a dicarboxylic acid diester with a diamine or a diisocyanate at a temperature of 150° C. or higher in the above-mentioned solvent. In order to accelerate the reaction, bases such as triethylamine and pyridine can be added as a catalyst. Then, the polymer can be charged in water or the like to precipitate the resin, and dried so that the polymer can be obtained as a solid.

((b) Basic Compound)

When the resin composition according to an embodiment of the present invention contains the basic compound (b), a phenolic hydroxyl group, a carboxyl group, or a sulfonic acid group contained in the resin (a) forms a salt with the basic compound (b). Accordingly, the solubility in water and dispersion stability of the resin composition are improved.

Examples of the basic compound (b) include hydroxides and carbonates of alkali metals and alkaline earth metals, and organic amines. In particular, a compound containing at least one element selected from alkali metals is preferable from the viewpoint of further improving the strength and chemical resistance of a coating film produced from the resin composition.

Examples of the alkali metal hydroxide include lithium hydroxide, sodium hydroxide, potassium hydroxide, rubidium hydroxide, and cesium hydroxide. The resin composition may contain two or more of them. From the viewpoint of improving the solubility in water and dispersion stability of the resin composition, lithium hydroxide, sodium hydroxide, and potassium hydroxide are preferable.

Examples of the alkali metal carbonate include lithium carbonate, lithium bicarbonate, sodium carbonate, sodium bicarbonate, potassium carbonate, potassium bicarbonate, rubidium bicarbonate, cesium carbonate, cesium bicarbonate, and potassium sodium carbonate. The resin composition may contain two or more of them. From the viewpoint of solubility in water and dispersion stability of the resin composition, sodium carbonate, sodium bicarbonate, potassium carbonate, potassium bicarbonate, and potassium sodium carbonate are preferable, and sodium carbonate and sodium bicarbonate are more preferable.

Examples of the organic amine include aliphatic tertiary amines such as trimethylamine, triethylamine, triisopropylamine, tributylamine, triethanolamine, and N-methylethanolamine, aromatic amines such as pyridine, N,N-dimethylaminopyridine, and lutidine, and quaternary ammonium salts such as tetramethylammonium hydroxide and tetraethylammonium hydroxide. Two or more of them may be used.

Among them, sodium carbonate and sodium hydroxide are particularly preferable for the basic compound (b).

The content of the basic compound (b) in the resin composition is preferably 20 mol % or more, more preferably 50 mol % or more based on 100 mol % of acidic functional groups in the resin (a) from the viewpoint that the resin can be sufficiently dissolved. On the other hand, the content of the basic compound (b) is preferably 450 mol % or less, more preferably 400 mol % or less, preferably 300 mol % or less, most preferably 250 mol % or less from the viewpoint that decomposition of the resin and generation of cracks in the coating film can be prevented.

The resin composition according to an embodiment of the present invention preferably has a pH of 4 to 12 when dissolved in water at a solid content concentration of 15 mass %.

If the pH is outside the above-mentioned range, when the resin composition contains the filler described later, the filler is poor in dispersibility, and a coating film produced from the resin composition has poor thickness uniformity, strength, and chemical resistance. From the viewpoint of further improving the above-mentioned characteristics, a preferable range of the pH of the resin composition is 5 or more and 10 or less.

The pH value is either one of a value obtained by dissolving, in water, a resin composition containing: (a) a resin containing at least one of a polyimide, a polyamideimide, and a polybenzoxazole, having at least one acidic functional group among a phenolic hydroxyl group, a carboxyl group, and a sulfonic acid group in a side chain, and having an acidic functional group concentration of 3.4 mol/kg or more; and (b) a basic compound at a concentration of 15 mass %, and a value obtained by dissolving, in water, a resin composition containing: (a) a resin containing at least one of a polyimide, a polyamideimide, and a polybenzoxazole, having at least one acidic functional group among a phenolic hydroxyl group, a carboxyl group, and a sulfonic acid group in a side chain, and having an acidic functional group concentration of 3.4 mol/kg or more; and (b) a basic compound, the resin composition having been fully extracted from a battery member, at a concentration of 15 mass %.

((c) Water)

The resin composition according to an embodiment of the present invention contains the water (c) as a solvent. From the viewpoint of stability of the aqueous solution, the water (c) in solvents preferably accounts for 80 mass % or more of solvents contained in the resin composition. The content of the water (c) is more preferably 90 mass % or more, most preferably 99 mass % or more.

The resin composition according to an embodiment of the present invention preferably contains 50 to 1,000,000 parts by mass of the water (c) based on 100 parts by mass of the resin (a). In general, from the viewpoint of coating properties, the content of the water (c) is preferably 50 parts by mass or more, more preferably 100 parts by mass or more based on 100 parts by mass of the resin (a) because it is possible to suppress the gelation. Further, the content of the water (c) is preferably 100,000 parts by mass or less, more preferably 3,000 parts by mass or less based on 100 parts by mass of the resin (a) because it is possible to suppress the decomposition.

The resin composition according to an embodiment of the present invention preferably has a viscosity in the range of 1 mPa·s to 100 Pa·s at 25° C. from the viewpoint of workability.

The resin composition according to an embodiment of the present invention preferably has a pH of 4 to 12. If the pH is outside the above-mentioned range, when the resin composition contains the filler described later, the filler is poor in dispersibility, and a coating film produced from the resin composition has poor thickness uniformity, strength, and chemical resistance. From the viewpoint of further improving the above-mentioned characteristics, a preferable range of the pH of the resin composition is 5 or more and 10 or less.

The pH in the present invention is a value measured using a pH meter (LAQUA F-71 manufactured by HORIBA, Ltd.). The calibration of pH is performed using the following five types of standard solutions (having a pH of 2, 4, 7, 9, and 12) as defined in JIS Z 8802 (2011) “Methods for determination of pH”.
pH 2 standard solution (oxalate)

0.05 mol/L aqueous potassium tetraoxalate solution
pH 4 standard solution (phthalate)

0.05 mol/L aqueous potassium hydrogen phthalate solution
pH 7 standard solution (neutral phosphate: a mixture of the following two aqueous solutions)

0.025 mol/L aqueous potassium dihydrogen phosphate solution

0.025 mol/L aqueous disodium hydrogen phosphate solution
pH 9 standard solution (borate)

0.01 mol/L aqueous sodium tetraborate (borax) solution
pH 12 standard solution

saturated aqueous calcium hydroxide solution

The resin composition according to an embodiment of the present invention may contain a surfactant and the like from the viewpoint of further improving the coating properties. The resin composition may also contain an organic solvent, such as lower alcohols including ethanol and isopropyl alcohol and polyhydric alcohols including ethylene glycol and propylene glycol. The content of the organic solvent in the resin composition is preferably 50 mass % or less, more preferably 10 mass % or less of the whole resin composition.

Although there is no particular limitation on the method for producing the resin composition according to an embodiment of the present invention, it is preferable from the viewpoint of safety to dissolve a predetermined amount of the basic compound in water, and then dissolving a resin powder little by little in the resulting solution. When a neutralization reaction proceeds slowly, it is possible to heat the solution in a water bath or an oil bath of about 30 to 110° C., or subject the solution to ultrasonic treatment. It is possible to adjust the resin solution to have a predetermined viscosity after the dissolution by further adding water to the solution or concentrating the solution.

((d) Filler)

The resin composition according to an embodiment of the present invention may contain the filler (d). When the resin composition contains the filler (d), a film produced from the resin composition has improved mechanical strength and heat resistance. Furthermore, when the filler (d) used is conductive particles or a high refractive index filler or a low refractive index filler, the resin composition can be used as an electronic material or an optical material. The resin composition containing the filler (d) may be in a slurry form.

Preferable examples of the filler (d) include compounds containing an atom of at least one element among carbon, manganese, aluminum, barium, cobalt, nickel, iron, silicon, titanium, tin, and germanium. These compounds serve as electrode active materials, strength reinforcements, thermal conductivity materials, or high dielectric materials. For this reason, when the resin composition according to an embodiment of the present invention contains a filler and is in a slurry form, the resin composition can be used as a slurry for functional elements, such as an electronic component, a secondary battery, and an electric double layer capacitor.

Examples of the filler for a cathode in a secondary battery or an electric double layer capacitor include lithium iron phosphate, lithium cobalt oxide, lithium nickel oxide, lithium manganese oxide, activated carbon, and carbon nanotubes.

Examples of the filler for an anode in a secondary battery or an electric double layer capacitor include silicon, silicon oxide, silicon carbide, tin, tin oxide, germanium, lithium titanate, hard carbon, soft carbon, activated carbon, and carbon nanotubes. In particular, a storage battery containing silicon, tin, or germanium as an active material undergoes a large volume expansion of the active material during charging, and therefore, it is preferable to use a resin having high mechanical strength, such as the resin (a), as the binder for preventing pulverization of the active material. In addition, when the filler is lithium titanate, a secondary battery or an electric double layer capacitor excellent in rate characteristics can be obtained.

Particularly preferable examples of the filler for an anode include fillers containing at least one of silicon, silicon oxide, lithium titanate, silicon carbide, a mixture of two or more of the materials, a mixture containing one of the materials or a mixture of two or more of the materials and carbon, and a product containing one of the materials or a mixture of two or more of the materials and having a carbon-coated surface. These active materials have a particularly strong binding property produced by the resin (a), and can provide a secondary battery or an electric double layer capacitor having a high capacity retention rate.

The content of the filler (d) in the resin composition according to an embodiment of the present invention is preferably 0.01 parts by mass or more, more preferably 0.1 parts by mass or more based on 100 parts by mass of the resin (a) from the viewpoint that a film obtained from the resin composition can have improved mechanical strength and heat resistance. The content of the filler (d) is preferably 100,000 parts by mass or less, more preferably 10,000 parts by mass or less from the viewpoint that the coating film strength of the resin composition can be maintained.

The slurry can be obtained, for example, by adding a filler and optionally other components to a resin dissolved or dispersed in water or a solvent, and mixing the components uniformly. Examples of the mixing method include a method using a planetary mixer, a planetary centrifugal mixer, a triple roll mill, a ball mill, a mechanical stirrer, a thin film swivel type mixer or the like.

<Laminate>

The laminate according to an embodiment of the present invention includes a base material, and a layer formed from the above-mentioned resin composition on at least one surface of the base material. The laminate can be obtained, for example, by applying the resin composition to one or two surfaces of a base material, and drying the resin composition.

Examples of a preferably used base material include pieces of metal foil such as copper foil, aluminum foil, and stainless steel foil, a silicon substrate, a glass substrate, and a plastic film. Examples of the coating method include a method using a roll coater, a slit die coater, a bar coater, a comma coater, a spin coater or the like. The drying temperature is preferably 30° C. or higher, more preferably 50° C. or higher for completely removing water. Moreover, the drying temperature is preferably 500° C. or lower, more preferably 200° C. or lower from the viewpoint of preventing cracks in the electrode.

Moreover, the resin composition according to an embodiment of the present invention, when used as an electrode slurry, may contain a conductive aid such as acetylene black, ketjen black, and carbon nanotubes. When the resin composition contains a conductive aid, the charge/discharge rate can be improved. The content of the conductive aid is preferably 0.1 to 20 parts by mass based on 100 parts by mass of the active material for achieving both conductivity and capacity.

Moreover, the resin composition according to an embodiment of the present invention may contain a sodium salt of carboxymethyl cellulose for viscosity adjustment. The content of the sodium salt of carboxymethyl cellulose is preferably 50 parts by mass or less based on 100 parts by mass of the active material from the viewpoint that a secondary battery or an electric double layer capacitor may have a high capacity retention rate.

The resin composition, or the resin composition containing a filler is applied to at least one surface of a base material and dried to form a film, whereby a laminate is formed. Examples of the base material include an insulating base material and a conductive base material. A conductive base material or an insulating base material having conductive wiring is preferable for use in an electronic device. In particular, an electrode of a secondary battery or an electric double layer capacitor can be obtained by applying a resin composition containing an electrode active material as a filler to one or two surfaces of a current collector such as a copper foil piece, an aluminum foil piece, or a stainless steel foil piece, and drying the resin composition. A plurality of the cathodes and anodes obtained in this manner are laminated with a separator interposed therebetween, and the resulting laminate is placed in an outer packaging material such as a metal case together with an electrolytic solution, and sealed, so that an electric storage device such as a secondary battery or an electric double layer capacitor can be obtained.

Examples of the separator include microporous films and non woven fabrics made of materials such as polyolefins including polyethylene and polypropylene, cellulose, polyphenylene sulfide, aramid, and polyimides.

As a solvent for the electrolytic solution, carbonate compounds such as propylene carbonate, ethylene carbonate, dimethyl carbonate, ethylmethyl carbonate, and vinylene carbonate, acetonitrile, sulfolane, γ-butyrolactone, and the like can be used. Two or more of them may be used.

Examples of the electrolyte include lithium salts such as lithium hexafluorophosphate, lithium borofluoride, and lithium perchlorate, and ammonium salts such as tetraethylammonium tetrafluoroborate and triethylmethylammonium tetrafluoroborate.

### EXAMPLES

Examples will be given below to describe the present invention in more detail, but the present invention is not limited to these examples. In the examples and comparative examples, calculation of the functional group concentration and measurement of the weight average molecular weight for the resins, measurement of the pH of the aqueous solutions, evaluation of stability of the aqueous solutions, evaluation of characteristics of films produced from slurries obtained from the aqueous solutions, and evaluation of battery characteristics were performed by the following methods.

<Method for Calculating Functional Group Concentration>

In accordance with the calculation method described in the above-mentioned section “EMBODIMENTS OF THE INVENTION”, the number A of acidic functional groups in a repeating unit in the resin (a) and the molecular weight B of the repeating unit were obtained, and the functional group concentration (mol/kg) was calculated from A/B×1000.

<Measurement of Weight Average Molecular Weight of Resins>

The molecular weight of resins A to N was measured by GPC (gel permeation chromatography), and the weight average molecular weight (Mw) was calculated by polystyrene conversion. Measurement conditions for the GPC are shown below.

1) Apparatus: Waters 2690

2) Columns: TOSOH CORPORATION, TSK-GEL (d-4000 and d-2500)

3) Solvent: NMP

4) Flow rate: 0.4 mL/min

5) Sample concentration: 0.05 to 0.1 wt %

6) Injection volume: 50 μL

7) Temperature: 40° C.

8) Detector: Waters 996

The polystyrene used for the conversion was the standard polystyrene manufactured by Polymer Laboratories Ltd.

<Measurement of pH of Aqueous Solutions>

Small amounts of aqueous solutions 1 to 21 were collected, and the pH of the aqueous solutions was measured using a pH meter (LAQUA F-71 manufactured by HORIBA, Ltd.). The calibration of pH was performed using the following five types of standard solutions (having a pH of 2, 4, 7, 9, and 12) as defined in JIS Z 8802 (2011) “Methods for determination of pH”.
pH 2 standard solution (oxalate)

0.05 mol/L aqueous potassium tetraoxalate solution
pH 4 standard solution (phthalate)

0.05 mol/L aqueous potassium hydrogen phthalate solution
pH 7 standard solution (neutral phosphate: a mixture of the following two aqueous solutions)

0.025 mol/L aqueous potassium dihydrogen phosphate solution

0.025 mol/L aqueous disodium hydrogen phosphate solution
pH 9 standard solution (borate)

0.01 mol/L aqueous sodium tetraborate (borax) Solution
pH 12 standard solution

saturated aqueous calcium hydroxide solution

<Stability Evaluation of Aqueous Solutions>

The aqueous solutions 1 to 21 were left to stand for 1 month and 3 months at room temperature and for 1 week and 1 month under refrigeration, and then visually observed to confirm the stability of the aqueous solutions. An aqueous solution for which neither precipitation nor gelation was observed was rated as good, and for an aqueous solution that underwent any change, the change was described. An aqueous solution rated as good after being left to stand for 1 month at room temperature was regarded as acceptable, and an aqueous solution that underwent any change after being left to stand for 1 month at room temperature was regarded as rejectable.

<Evaluation of Characteristics of Films (Evaluation of Dispersibility and Binding Property)>

In order to examine the dispersibility of a filler and the binding property as a binder, the film characteristics of resin compositions containing a filler were evaluated. When the dispersibility of a filler and the binding property as a binder are poor, the uniformity of the film thickness may be deteriorated due to the aggregation of the filler, or cracks may be generated in the film.

Mixed and dispersed were 80 parts by mass of the anode active material for a lithium-ion battery obtained in Synthesis Example 19, 100 parts by mass of any of aqueous solutions 1 to 21 (solid content concentration: 15 mass %), 5 parts by mass of acetylene black as a conductive aid, and 15 parts by mass of water to produce a slurry having a solid content of 50 mass %.

The slurry was applied to an aluminum foil piece using a bar coater into a width of 10 cm while adjusting the thickness so that the film after the heat treatment would have an average thickness of 25 μm. After the application, the film was dried at 50° C. for 30 minutes, then heated to 150° C. over 30 minutes, heat-treated at 150° C. for 1 hour, and then cooled to 50° C. or lower. After cooling, the film was visually observed to check for presence or absence of cracks. A film without a crack was rated as “good”, and a film with any crack observed was rated as “defective”.

Moreover, ten points were selected at equal intervals in the width direction in a region inside of 5 mm from both ends of the applied slurry on the aluminum foil piece, and the film thicknesses at the ten points after the heat treatment were measured with a micrometer. Of the maximum value and the minimum value of the measured values, a value having a larger difference from the average value (25 μm) was regarded as T1. The film thickness variation T2 was calculated from

T2=(T1−25)/25*100(%),

and defined as ±T2%. A sample having a variation in the range of −30% to +30% (except for exact ±30%) was regarded as acceptable, and a sample having a variation outside the range was regarded as rejectable.

Further, five circular pieces each having a diameter of 16 mm were cut out of the film, immersed in a solution containing a mixture of each 50% by weight of diethyl carbonate and ethylene carbonate, and left to stand at 40° C. for 24 hours and 1 week. After being left to stand, the film pieces were taken out of the solution, washed with water, dried at 50° C. for 1 hour, and visually observed to confirm the presence or absence of dissolution of the film and the presence or absence of cracks. A sample with dissolution of the film observed was evaluated as “dissolved”, a sample with any crack was evaluated as “defective”, and a sample without any dissolution of the film or crack observed was evaluated as “good”.

In addition, a sample having a thickness adjusted so that the film after the heat treatment would have an average thickness of 50 μm was produced by the same method as described above. Five circular pieces each having a diameter of 16 mm were cut out of the film, immersed in a solution containing a mixture of each 50% by weight of diethyl carbonate and ethylene carbonate, and left to stand at 40° C. for 1 week. After being left to stand, the film pieces were taken out of the solution, washed with water, dried at 50° C. for 1 hour, and visually observed to confirm the presence or absence of dissolution of the film and the presence or absence of cracks. A sample with dissolution of the film observed was evaluated as “dissolved”, a sample with any crack was evaluated as “defective”, and a sample without any dissolution of the film or crack observed was evaluated as “good”.

<Evaluation of Battery Characteristics>

(1) Production of Anode

Each of the slurries having a solid content of 50% produced in <Evaluation of characteristics of films (evaluation of dispersibility and binding property)> was applied to an electrolytic copper foil piece using a bar coater while adjusting the thickness so that the film after the heat treatment at 150° C. would have a thickness of 25 μm, and the film after the application was dried at 110° C. for 30 minutes. After drying, the part of the copper foil piece to which the slurry was applied was punched out into a circle having a diameter of 16 mm, and the circular piece was vacuum-dried at 150° C. for 24 hours to produce an anode.

(2) Evaluation of Battery Characteristics

For measuring the charge/discharge characteristics, an HS cell (manufactured by Hohsen Corp.) was used, and a lithium-ion battery was assembled in a nitrogen atmosphere. As a separator, a polyethylene porous film (manufactured by Hohsen Corp.) punched out to have a diameter of 24 mm was used. As a cathode, a material that is obtained by firing an active material made of lithium cobalt oxide on an aluminum foil piece (the material is manufactured by Hohsen Corp.) and was punched out to have a diameter of 16 mm was used. The anode, separator, and cathode were stacked in this order, 1 mL of MIRET 1 (manufactured by Mitsui Chemicals, Inc.) was injected as an electrolytic solution, and the resulting product was sealed to produce a lithium-ion battery.

The lithium-ion battery produced as described above was charged and discharged. As for the charging and discharging, the following operation was performed as one cycle: the battery was charged at a constant current of 6 mA until the battery voltage reached 4.2 V, and further charged at a constant voltage of 4.2 V until the charging time reached a total of 2 hours and 30 minutes from the start of charging, then a pause of 30 minutes was provided, and the battery was discharged at a constant current of 6 mA until the battery voltage reached 2.7 V. Then, charging and discharging were repeated 49 times under the same conditions, and the charge capacity and discharge capacity of each cycle were measured for the total of 50 cycles. The capacity retention rate was calculated according to the following equation.

Capacity retention rate (%)=(discharge capacity at 50th cycle/discharge capacity at 1st cycle)×100

### Synthesis Example 1: Synthesis of Resin A

In a well-dried four-necked flask, 29.84 g (100 mmol) of 3,3′-dicarboxy-4,4′-methylenebis(cyclohexylamine) (manufactured by Tokyo Chemical Industry Co., Ltd., hereinafter referred to as “CMCHA”) was dissolved in 131.79 g of NMP at room temperature with stirring in a nitrogen atmosphere. Then, 31.02 g (100 mmol) of 3,3′,4,4′-diphenyl ether tetracarboxylic dianhydride (manufactured by Tokyo Chemical Industry Co., Ltd., hereinafter referred to as “ODPA”) and 15.00 g of NMP were added, and the resulting mixture was subjected to polymerization reaction at 40° C. for 1 hour, and then at 200° C. for 6 hours with water generated during the reaction being distilled off. After completion of the reaction, the temperature was lowered to room temperature, the resulting solution was poured into 3 L of water, and the resulting precipitate was filtered off and washed three times with 1.5 L of water. The washed solid was dried in a ventilated oven at 50° C. for 3 days to produce a solid of the resin A. The resin A had a weight average molecular weight of 30,000.

### Synthesis Example 2: Synthesis of Resin B

A solid of the resin B was obtained in the same manner as in Synthesis Example 1 except that 20.89 g (70 mmol) of CMCHA and 8.59 g (30 mmol) of 3,3′-dicarboxy-4,4′-diaminodiphenylmethane (manufactured by Wakayama Seika Kogyo Co., Ltd., trade name “MBAA”) were used instead of 29.84 g (100 mmol) of CMCHA. The resin B had a weight average molecular weight of 32,000.

### Synthesis Example 3: Synthesis of Resin C

A solid of the resin C was obtained in the same manner as in Synthesis Example 1 except that 28.63 g (100 mmol) of MBAA was used instead of 29.84 g (100 mmol) of CMCHA. The resin C had a weight average molecular weight of 35,000.

### Synthesis Example 4: Synthesis of Resin D

In a well-dried four-necked flask, 28.63 g (100 mmol) of MBAA was dissolved in 131.79 g of NMP at room temperature with stirring in a nitrogen atmosphere. Then, 30.00 g (100 mmol) of 1,3,3a,4,5,9b-hexahydro-5-(tetrahydro-2,5-dioxo-3-furanyl)naphtho[1,2-c]furan-1,3-dione (manufactured by New Japan Chemical Co., Ltd., trade name “RIKACID TDA-100”) and 15.00 g of NMP were added, and the resulting mixture was subjected to polymerization reaction at 40° C. for 1 hour, and then at 200° C. for 6 hours with water generated during the reaction being distilled off. After completion of the reaction, the temperature was lowered to room temperature, the resulting solution was poured into 3 L of water, and the resulting precipitate was filtered off and washed three times with 1.5 L of water. The washed solid was dried in a ventilated oven at 50° C. for 3 days to produce a solid of the resin D. The resin D had a weight average molecular weight of 18,000.

### Synthesis Example 5: Synthesis of Resin E

A solid of the resin E was obtained in the same manner as in Synthesis Example 4 except that 24.82 g (100 mmol) of bicyclo[2,2,2]oct-7-ene-2,3,5,6-tetracarboxylic dianhydride (manufactured by Tokyo Chemical Industry Co., Ltd., hereinafter referred to as “BOE”) was used instead of 30.00 g (100 mmol) of TDA-100. The resin E had a weight average molecular weight of 15,000.

### Synthesis Example 6: Synthesis of Resin F

A solid of the resin F was obtained in the same manner as in Synthesis Example 4 except that 22.42 g (100 mmol) of 3-(carboxymethyl)-1,2,4-cyclopentanetricarboxylic acid 1,4:2,3-dianhydride (manufactured by Tokyo Chemical Industry Co., Ltd., hereinafter referred to as “JPDA”) was used instead of 30.00 g (100 mmol) of TDA-100. The resin F had a weight average molecular weight of 20,000.

### Synthesis Example 7: Synthesis of Resin G

A solid of the resin G was obtained in the same manner as in Synthesis Example 4 except that 21.81 g (100 mmol) of pyromellitic dianhydride (manufactured by DAICEL CORPORATION, trade name “PMDA”) was used instead of 30.00 g (100 mmol) of TDA-100. The resin G had a weight average molecular weight of 28,000.

### Synthesis Example 8: Synthesis of Resin H

A solid of the resin H was obtained in the same manner as in Synthesis Example 4 except that 21.01 g (100 mmol) of 1,2,3,4-cyclopentanetetracarboxylic dianhydride (manufactured by Tokyo Chemical Industry Co., Ltd., hereinafter referred to as “CPDA”) was used instead of 30.00 g (100 mmol) of TDA-100. The resin H had a weight average molecular weight of 16,000.

### Synthesis Example 9: Synthesis of Resin I

A solid of the resin I was obtained in the same manner as in Synthesis Example 4 except that 19.61 g (100 mmol) of 1,2,3,4-cyclobutanetetracarboxylic dianhydride (manufactured by Tokyo Chemical Industry Co., Ltd., hereinafter referred to as “CBDA”) was used instead of 30.00 g (100 mmol) of TDA-100. The resin I had a weight average molecular weight of 25,000.

### Synthesis Example 10: Synthesis of Resin J

A solid of the resin J was obtained in the same manner as in Synthesis Example 4 except that 19.81 g (100 mmol) of 1,2,3,4-butanetetracarboxylic dianhydride (manufactured by WAKO Pure Chemical Industries, Ltd., hereinafter referred to as “BTA”) was used instead of 30.00 g (100 mmol) of TDA-100. The resin J had a weight average molecular weight of 35,000.

### Synthesis Example 11: Synthesis of Resin K

In a well-dried four-necked flask, 26.63 g (93 mmol) of MBAA and 0.75 g (3 mmol) of APDS were dissolved in 131.79 g of NMP at room temperature with stirring in a nitrogen atmosphere. Then, 19.81 g (100 mmol) of BTA and 15.00 g of NMP were added, and the resulting mixture was subjected to reaction at 40° C. for 1 hour. Then, 1.10 g (8 mmol) of 4-aminobenzoic acid (manufactured by Tokyo Chemical Industry Co., Ltd., hereinafter referred to as “4ABA”) was added, and the resulting mixture was further subjected to reaction at 40° C. for 1 hour. Then, the mixture was subjected to polymerization reaction at 200° C. for 6 hours with water generated during the reaction being distilled off. After completion of the reaction, the temperature was lowered to room temperature, the resulting solution was poured into 3 L of water, and the resulting precipitate was filtered off and washed three times with 1.5 L of water. The washed solid was dried in a ventilated oven at 50° C. for 3 days to produce a solid of the resin K. The resin K had a weight average molecular weight of 30,000.

### Synthesis Example 12: Synthesis of Resin L

A solid of the resin L was obtained in the same manner as in Synthesis Example 4 except that 44.42 (100 mmol) of 2,2-bis(3,4-dicarboxyphenyl)hexafluoropropane dianhydride (manufactured by Tokyo Chemical Industry Co., Ltd., hereinafter referred to as “6FDA”) was used instead of 30.00 g (100 mmol) of TDA-100. The resin L had a weight average molecular weight of 65,000.

### Synthesis Example 13: Synthesis of Resin M

In a well-dried four-necked flask, 14.44 g (95 mmol) of 3,5-diaminobenzoic acid (manufactured by Tokyo Chemical Industry Co., Ltd., hereinafter referred to as “DAB”) and 1.24 g (5 mmol) of 1,3-bis-3-aminopropyltetramethyldisiloxane (manufactured by Dow Corning Toray Silicone Co., Ltd., trade name “APDS”) were dissolved in 131.79 g of NMP at room temperature with stirring in a nitrogen atmosphere. Then, 31.02 g (100 mmol) of ODPA and 15.00 g of NMP were added, and the resulting mixture was subjected to polymerization reaction at 40° C. for 1 hour, and then at 200° C. for 6 hours with water generated during the reaction being distilled off. After completion of the reaction, the temperature was lowered to room temperature, the resulting solution was poured into 3 L of water, and the resulting precipitate was filtered off and washed three times with 1.5 L of water. The washed solid was dried in a ventilated oven at 50° C. for 3 days to produce a solid of the resin M. The resin M had a weight average molecular weight of 48,000.

### Synthesis Example 14: Synthesis of Resin N

In a well-dried four-necked flask, 28.63 g (100 mmol) of MBAA was dissolved in 131.79 g of NMP at room temperature with stirring in a nitrogen atmosphere. Then, while the temperature of the solution was maintained at 10° C. or lower, 20.30 (100 mmol) of isophthaloyl chloride (manufactured by Tokyo Chemical Industry Co., Ltd., hereinafter referred to as “IPC”) and 15.00 g of NMP were added, and the resulting mixture was subjected to polymerization reaction at 10° C. or lower for 1 hour, and then at 23° C. for 6 hours. After completion of the reaction, the resulting solution was poured into 3 L of water, and the resulting precipitate was filtered off and washed three times with 1.5 L of water. The washed solid was dried in a ventilated oven at 50° C. for 3 days to produce a solid of the resin N. The resin N had a weight average molecular weight of 30,000.

The compositions, molecular weights, and functional group concentrations of the resins of Synthesis Examples 1 to 14 are shown in Table 1.

### Synthesis Example 15: Synthesis of Resin 0

In a well-dried four-necked flask, 27.20 g (95 mmol) of MBAA and 0.54 g (5 mmol) of paraphenylenediamine (manufactured by Tokyo Chemical Industry Co., Ltd., hereinafter referred to as “PDA”) were dissolved in 131.79 g of NMP at room temperature with stirring in a nitrogen atmosphere. Then, 19.81 g (100 mmol) of BTA and 15.00 g of NMP were added, and the resulting mixture was subjected to reaction at 40° C. for 2 hours. Then, the mixture was subjected to polymerization reaction at 200° C. for 6 hours with water generated during the reaction being distilled off. After completion of the reaction, the temperature was lowered to room temperature, the resulting solution was poured into 3 L of water, and the resulting precipitate was filtered off and washed three times with 1.5 L of water. The washed solid was dried in a ventilated oven at 50° C. for 3 days to produce a solid of the resin O. The resin O had a weight average molecular weight of 35,000.

### Synthesis Example 16: Synthesis of Resin P

In a well-dried four-necked flask, 27.20 g (95 mmol) of MBAA, 0.43 g (4 mmol) of PDA, and 0.10 g (1 mmol) of 2,2′-oxybis(ethylamine) (manufactured by Tokyo Chemical Industry Co., Ltd., hereinafter referred to as “OBEA”) were dissolved in 131.79 g of NMP at room temperature with stirring in a nitrogen atmosphere. Then, 19.81 g (100 mmol) of BTA and 15.00 g of NMP were added, and the resulting mixture was subjected to reaction at 40° C. for 2 hours. Then, the mixture was subjected to polymerization reaction at 200° C. for 6 hours with water generated during the reaction being distilled off. After completion of the reaction, the temperature was lowered to room temperature, the resulting solution was poured into 3 L of water, and the resulting precipitate was filtered off and washed three times with 1.5 L of water. The washed solid was dried in a ventilated oven at 50° C. for 3 days to produce a solid of the resin P. The resin P had a weight average molecular weight of 35,000.

### Synthesis Example 17: Synthesis of Resin Q

In a well-dried four-necked flask, 27.20 g (95 mmol) of MBAA, 0.32 g (3 mmol) of PDA, and 0.10 g (1 mmol) of OBEA were dissolved in 131.79 g of NMP at room temperature with stirring in a nitrogen atmosphere. Then, 19.81 g (100 mmol) of BTA and 15.00 g of NMP were added, and the resulting mixture was subjected to reaction at 40° C. for 1 hour. Then, 0.28 g (2 mmol) of 4ABA was added, and the resulting mixture was further subjected to reaction at 40° C. for 1 hour. Then, the mixture was subjected to polymerization reaction at 200° C. for 6 hours with water generated during the reaction being distilled off. After completion of the reaction, the temperature was lowered to room temperature, the resulting solution was poured into 3 L of water, and the resulting precipitate was filtered off and washed three times with 1.5 L of water. The washed solid was dried in a ventilated oven at 50° C. for 3 days to produce a solid of the resin Q. The resin Q had a weight average molecular weight of 30,000.

### Synthesis Example 18: Synthesis of Resin R

A solid of the resin R was obtained in the same manner as in Synthesis Example 4 except that 26.42 g (100 mmol) of 5-(2,5-dioxotetrahydrofuryl)-3-methyl-3-cyclohexene-1,2-dicarboxylic anhydride (manufactured by DIC Corporation, trade name “EPICLON B-4400”) was used instead of 30.00 g (100 mmol) of TDA-100. The resin R had a weight average molecular weight of 20,000.

TABLE 1

| | | Diamine 1 | | | Diamine 2 | | Diamine 2 | |
|---|---|---|---|---|---|---|---|---|
| Resin | Diamine 1 | equivalent | | Diamine 2 | equivalent | Diamine 2 | equivalent | Acid |
| Resin A | CMCHA | 100 | mmol | — | — | — | — | ODPA |
| Resin B | CMCHA | 70 | mmol | MBAA | 30 mmol | — | — | ODPA |
| Resin C | MBAA | 100 | mmol | — | — | — | — | ODPA |
| Resin D | MBAA | 100 | mmol | — | — | — | — | TDA-100 |
| Resin E | MBAA | 100 | mmol | — | — | — | — | BOE |
| Resin F | MBAA | 100 | mmol | — | — | — | — | JPDA |
| Resin G | MBAA | 100 | mmol | — | — | — | — | PMDA |
| Resin H | MBAA | 100 | mmol | — | — | — | — | CPDA |
| Resin I | MBAA | 100 | mmol | — | — | — | — | CBDA |
| Resin J | MBAA | 100 | mmol | — | — | — | — | BTA |
| Resin K | MBAA | 93 | mmol | APDS | 3 mmol | — | — | BTA |
| Resin L | MBAA | 100 | mmol | — | — | — | — | 6FDA |
| Resin M | DAB | 95 | mmol | APDS | 5 mmol | — | — | ODPA |
| Resin N | MBAA | 100 | mmol | — | — | — | — | IPC |
| Resin O | MBAA | 95 | mmol | PDA | 5 mmol | | | BTA |
| Resin P | MBAA | 95 | mmol | PDA | 4 mmol | OBEA | 1 mmol | BTA |
| Resin Q | MBAA | 95 | mmol | PDA | 3 mmol | OBEA | 1 mmol | BTA |
| Resin R | MBAA | 100 | mmol | — | — | — | — | B-4400 |

| | | | | Weight | Functional |
|---|---|---|---|---|---|
| | Acid | | | average | group |
| | compound | Terminal | Terminal | molecular | concentration |
| Resin | equivalent | structure | equivalent | weight | (mol/kg) |
| Resin A | 100 mmol | — | — | 30000 | 3.49 |
| Resin B | 100 mmol | — | — | 32000 | 3.51 |
| Resin C | 100 mmol | — | — | 35000 | 3.57 |
| Resin D | 100 mmol | — | — | 18000 | 3.63 |
| Resin E | 100 mmol | — | — | 15000 | 4.01 |
| Resin F | 100 mmol | — | — | 20000 | 4.21 |
| Resin G | 100 mmol | — | — | 28000 | 4.27 |
| Resin H | 100 mmol | — | — | 16000 | 4.34 |
| Resin I | 100 mmol | — | — | 25000 | 4.48 |
| Resin J | 100 mmol | — | — | 35000 | 4.46 |
| Resin K | 100 mmol | 4ABA | 8 mmol | 30000 | 4.34 |
| Resin L | 100 mmol | — | — | 65000 | 2.88 |
| Resin M | 100 mmol | — | — | 48000 | 2.2 |
| Resin N | 100 mmol | — | — | 30000 | 4.8 |
| Resin O | 100 mmol | — | — | 35000 | 4.32 |
| Resin P | 100 mmol | — | — | 35000 | 4.32 |
| Resin Q | 100 mmol | 4ABA | 2 mmol | 30000 | 4.35 |
| Resin R | 100 mmol | | | 20000 | 3.89 |

### Synthesis Example 19: Synthesis of Anode Active Material for Lithium-Ion Battery

Mixed were 50 g of natural graphite having a particle size of about 10 μm (manufactured by Fuji Graphite Works Co., Ltd., CBF1), 60 g of a nanosilicon powder (manufactured by Sigma-Aldrich), and 10 g of carbon black (manufactured by Mitsubishi Chemical Corporation, 3050), and the resulting mixture was well dispersed in a ball mill at 600 rpm for 12 hours, and then vacuum-dried at 80° C. for 12 hours to produce a silicon-carbon mixed anode active material.

Aqueous Solutions 1 to 21

A resin, a basic compound, and water were mixed as shown in Table 1 to prepare an aqueous solution having a solid content concentration of 15 mass %. The compositions of the aqueous solutions 1 to 21 and the pH values of the aqueous solutions are shown in Table 2.

TABLE 2

| | | | Basic compound | | | | | | |
|---|---|---|---|---|---|---|---|---|---|
| | | | | Equivalent | | | | | pH of aqueous |
| | | | | relative to | | | | | solution |
| | | | | acidic groups | | | | | having |
| | Resin | | | of resin | | | Amount of | Concentration | concentration |
| Aqueous solution | Type | Amount | Type | (mol %) | Amount | | water | (%) | of 15% |
| Aqueous solution 1 | Resin A | 20.00 g | Na₂CO₃ | 300 | 22.21 | g | 226.32 g | 15% | 11 |
| Aqueous solution 2 | Resin B | 20.00 g | Na₂CO₃ | 300 | 22.36 | g | 227.03 g | 15% | 11 |
| Aqueous solution 3 | Resin C | 20.00 g | Na₂CO₃ | 300 | 22.69 | g | 228.75 g | 15% | 11 |
| Aqueous solution 4 | Resin D | 20.00 g | Na₂CO₃ | 250 | 19.26 | g | 209.06 g | 15% | 10 |
| Aqueous solution 5 | Resin E | 20.00 g | Na₂CO₃ | 200 | 17.01 | g | 194.91 g | 15% | 9 |
| Aqueous solution 6 | Resin F | 20.00 g | Na₂CO₃ | 200 | 17.87 | g | 199.04 g | 15% | 9 |
| Aqueous solution 7 | Resin G | 20.00 g | Na₂CO₃ | 250 | 22.63 | g | 225.80 g | 15% | 10 |
| Aqueous solution 8 | Resin H | 20.00 g | Na₂CO₃ | 200 | 18.42 | g | 201.66 g | 15% | 9 |
| Aqueous solution 9 | Resin I | 20.00 g | Na₂CO₃ | 200 | 19.00 | g | 204.43 g | 15% | 9 |
| Aqueous solution 10 | Resin J | 20.00 g | Na₂CO₃ | 50 | 4.73 | g | 123.65 g | 15% | 7 |
| Aqueous solution 11 | Resin J | 20.00 g | NaOH | 100 | 3.57 | g | 122.85 g | 15% | 11 |
| Aqueous solution 12 | Resin K | 20.00 g | Na₂CO₃ | 50 | 4.60 | g | 123.38 g | 15% | 7 |
| Aqueous solution 13 | Resin L | 20.00 g | Na₂CO₃ | 200 | 12.21 | g | 171.89 g | 15% | 9 |
| Aqueous solution 14 | Resin M | 20.00 g | NaOH | 200 | 3.53 | g | 128.03 g | 15% | 13 |
| Aqueous solution 15 | Resin N | 20.00 g | NaOH | 150 | 5.77 | g | 134.47 g | 15% | 12 |
| Aqueous solution 16 | Resin G | 20.00 g | NaOH | 250 | 8.54 | g | 151.48 g | 15% | 14 |
| Aqueous solution 17 | Resin O | 20.00 g | Na₂CO₃ | 50 | 4.58 | g | 123.33 g | 15% | 7 |
| Aqueous solution 18 | Resin P | 20.00 g | Na₂CO₃ | 50 | 4.58 | g | 123.34 g | 15% | 7 |
| Aqueous solution 19 | Resin Q | 20.00 g | Na₂CO₃ | 50 | 4.61 | g | 123.40 g | 15% | 7 |
| Aqueous solution 20 | Resin R | 20.00 g | Na₂CO₃ | 250 | 20.60 | g | 215.72 g | 15% | 10 |
| Aqueous solution 21 | Resin D | 20.00 g | Triethylamine | 100 | 7.36 | g | 155.01 g | 15% | 9 |

### Examples 1 to 17 and Comparative Examples 1 to 4

The stability of the aqueous solutions shown in Table 2 and the film characteristics of the films obtained using slurries produced from the aqueous solutions were evaluated. The evaluation results are shown in Table 3.

TABLE 3

| | | Storage at room | | Storage under | |
|---|---|---|---|---|---|
| | | temperature | | refrigeration | |
| | Aqueous solution | 1 month | 3 months | 1 week | 1 month |
| Example 1 | Aqueous | Good | Precipitated | Precipitated | Precipitated |
| | solution 1 | | | | |
| Example 2 | Aqueous | Good | Good | Precipitated | Precipitated |
| | solution 2 | | | | |
| Example 3 | Aqueous | Good | Good | Precipitated | Precipitated |
| | solution 3 | | | | |
| Example 4 | Aqueous | Good | Good | Good | Precipitated |
| | solution 4 | | | | |
| Example 5 | Aqueous | Good | Good | Good | Precipitated |
| | solution 5 | | | | |
| Example 6 | Aqueous | Good | Good | Good | Precipitated |
| | solution 6 | | | | |
| Example 7 | Aqueous | Good | Good | Good | Precipitated |
| | solution 7 | | | | |
| Example 8 | Aqueous | Good | Good | Good | Good |
| | solution 8 | | | | |
| Example 9 | Aqueous | Good | Good | Good | Good |
| | solution 9 | | | | |
| Example 10 | Aqueous | Good | Good | Good | Good |
| | solution 10 | | | | |
| Example 11 | Aqueous | Good | Good | Good | Good |
| | solution 11 | | | | |
| Example 12 | Aqueous | Good | Good | Good | Good |
| | solution 12 | | | | |
| Example 13 | Aqueous | Good | Good | Good | Good |
| | solution 17 | | | | |
| Example 14 | Aqueous | Good | Good | Good | Good |
| | solution 18 | | | | |
| Example 15 | Aqueous | Good | Good | Good | Good |
| | solution 19 | | | | |
| Example 16 | Aqueous | Good | Good | Good | Precipitated |
| | solution 20 | | | | |
| Example 17 | Aqueous | Good | Good | Good | Precipitated |
| | solution 21 | | | | |
| Comparative | Aqueous | Precipitated | Precipitated | Precipitated | Precipitated |
| Example 1 | solution 13 | | | | |
| Comparative | Aqueous | Precipitated | Precipitated | Precipitated | Precipitated |
| Example 2 | solution 14 | | | | |
| Comparative | Aqueous | Good | Good | Good | Good |
| Example 3 | solution 15 | | | | |
| Comparative | Aqueous | Good | Good | Good | Precipitated |
| Example 4 | solution 16 | | | | |

| | | Crack of film over aluminum foil piece | | | |
|---|---|---|---|---|---|
| | Variation in | | | | Film |
| | thickness of | Film thickness 25 μm | | | thickness |
| | film over | Immediately | 24 h After | 1 week After | 50 μm |
| | aluminum foil | after film | immersion in | immersion in | After |
| | piece (%) | formation | solution | solution | solution |
| Example 1 | 25 | Good | Good | Defective | Defective |
| Example 2 | 25 | Good | Good | Defective | Defective |
| Example 3 | 25 | Good | Good | Defective | Defective |
| Example 4 | 25 | Good | Good | Good | Defective |
| Example 5 | 20 | Good | Good | Good | Defective |
| Example 6 | 20 | Good | Good | Good | Defective |
| Example 7 | 20 | Good | Good | Good | Defective |
| Example 8 | 15 | Good | Good | Good | Defective |
| Example 9 | 15 | Good | Good | Good | Defective |
| Example 10 | 10 | Good | Good | Good | Defective |
| Example 11 | 10 | Good | Good | Defective | Defective |
| Example 12 | 5 | Good | Good | Good | Defective |
| Example 13 | 10 | Good | Good | Good | Good |
| Example 14 | 8 | Good | Good | Good | Good |
| Example 15 | 3 | Good | Good | Good | Good |
| Example 16 | 25 | Good | Good | Good | Defective |
| Example 17 | 25 | Good | Defective | Defective | Defective |
| Comparative | 30 | Good | Good | Good | Defective |
| Example 1 | | | | | |
| Comparative | 30 | Defective | Defective | Defective | Defective |
| Example 2 | | | | | |
| Comparative | 30 | Good | Good | Defective | Defective |
| Example 3 | | | | | |
| Comparative | 20 | Defective | Defective | Defective | Defective |
| Example 4 | | | | | |

### Examples 18 to 26 and Comparative Examples 5 to 7

The battery characteristics of the films obtained using slurries produced from the aqueous solutions shown in Table 2 were evaluated. The evaluation results are shown in Table 4.

TABLE 4

| | | | Capacity retention |
|---|---|---|---|
| | Resin | Aqueous solution | rate (%) |
| Example 18 | Resin A | Aqueous solution 1 | 75 |
| Example 19 | Resin G | Aqueous solution 7 | 80 |
| Example 20 | Resin I | Aqueous solution 9 | 85 |
| Example 21 | Resin J | Aqueous solution 11 | 90 |
| Example 22 | Resin J | Aqueous solution 10 | 93 |
| Example 23 | Resin K | Aqueous solution 12 | 93 |
| Example 24 | Resin O | Aqueous solution 17 | 95 |
| Example 25 | Resin P | Aqueous solution 18 | 97 |
| Example 26 | Resin Q | Aqueous solution 19 | 97 |
| Comparative | Resin L | Aqueous solution 13 | 50 |
| Example 5 | | | |
| Comparative | Resin N | Aqueous solution 15 | 70 |
| Example 6 | | | |
| Comparative | Resin G | Aqueous solution 16 | 60 |
| Example 7 | | | |
| Comparative | PVdf | — | 35 |
| Example 8 | | | |

### Comparative Example 8

Mixed and dispersed were 80 parts by mass of the anode active material for a lithium-ion battery obtained in Synthesis Example 15, 15 parts by mass of polyvinylidene fluoride (manufactured by KISHIDA CHEMICAL Co., Ltd., hereinafter referred to as “PVdF”), 5 parts by mass of acetylene black as a conductive aid, and 100 parts by mass of NMP to produce a slurry having a solid content of 50 mass %. The results of battery characteristics evaluation performed using the slurry are shown in Table 4.

1. A resin composition comprising:
(a) a resin containing at least one of a polyimide, a polyamideimide, and a polybenzoxazole, having at least one acidic functional group among a phenolic hydroxyl group, a carboxyl group, and a sulfonic acid group in a side chain, and having an acidic functional group concentration of 3.4 mol/kg or more; and
(b) a basic compound.

2. The resin composition according to claim 1, having a pH of 4 to 12 when dissolved in water at a solid content concentration of 15 mass %.

3. The resin composition according to claim 1, further comprising (c) water, and having a pH of 4 to 12.

4. The resin composition according to claim 1, wherein the resin (a) contains a structure represented by a general formula (1) shown below as a repeating unit: 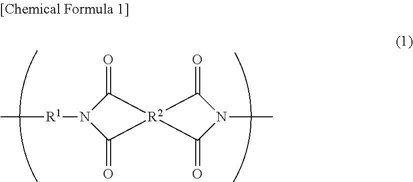
wherein R¹ represents a divalent organic group having 2 to 50 carbon atoms, and includes at least one of a phenolic hydroxyl group, a carboxyl group, and a sulfonic acid group, and R² represents a trivalent or tetravalent organic group having 2 to 50 carbon atoms.

5. The resin composition according to claim 4, wherein, in the general formula (1), R² is at least one structure selected from structures shown below: 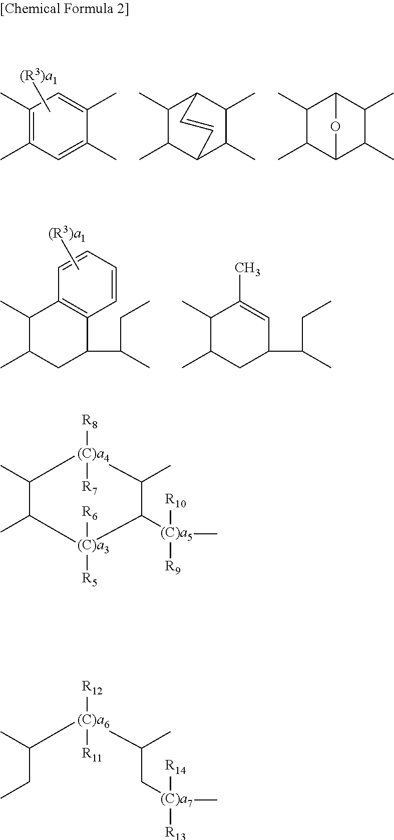
wherein R³ and R⁴ each independently represent a halogen atom or an organic group having 1 to 6 carbon atoms, R⁵ to R¹⁴ each independently represent a hydrogen atom, a halogen atom, or an organic group having 1 to 6 carbon atoms, a₁ is an integer of 0 to 2, a₂ is an integer of 0 to 4, a₃ and a₄ are each independently an integer of 0 to 4, and a₃+a₄<5, a₆ is an integer of 0 to 6, and as and a′ are each independently an integer of 0 to 2.

6. The resin composition according to claim 4, comprising, in a total number of the structure represented by the general formula (1) contained in the resin (a), 20 mol % or more of a structure in which R¹ has an aromatic skeleton.

7. The resin composition according to claim 4, wherein, in the general formula (1), R¹ is at least one of general formulae (2) and (3) shown below: 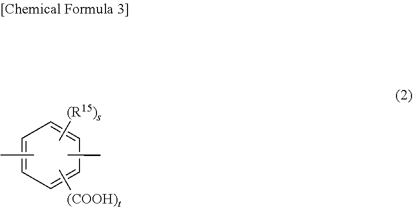
wherein R¹⁵ represents a halogen atom or a monovalent organic group having 1 to 8 carbon atoms, s represents an integer of 0 to 3, and t represents an integer of 1 or 2; and 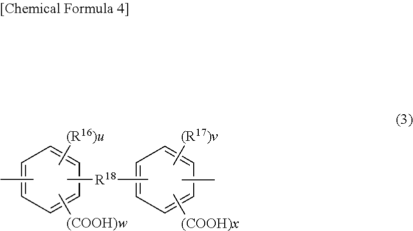
wherein R¹⁶ and R¹⁷ each independently represent a halogen atom or a monovalent organic group having 1 to 8 carbon atoms, u and v each independently represent an integer of 0 to 3, w and x each independently represent an integer of 1 or 2, and R¹⁸ is a single bond, O, S, NH, SO₂, CO, or a divalent organic group having 1 to 3 carbon atoms.

8. The resin composition according to claim 4, wherein, further in the general formula (1), 1 to 25 mol % of R¹ is at least one of general formulae (4) and (5) shown below: 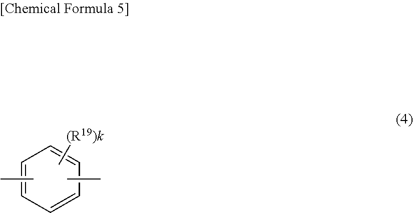
wherein R¹⁹ represents a halogen atom or a monovalent organic group having 1 to 8 carbon atoms, and k represents an integer of 0 to 4; and 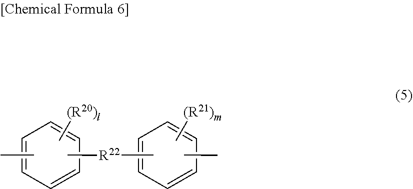
wherein R²⁰ and R²¹ each independently represent a halogen atom or a monovalent organic group having 1 to 8 carbon atoms, 1 and m each independently represent an integer of 0 to 4, and R²² is a single bond, O, S, NH, SO₂, CO, or a divalent organic group having 1 to 3 carbon atoms.

9. The resin composition according to claim 4, wherein, further in the general formula (1), 0.1 to 10 mol % of R¹ is a general formula (6) shown below: 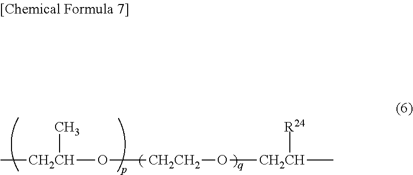
wherein R²⁴ represents hydrogen or a methyl group, and p and q each independently represent an integer of 0 or more, and 1<p+q<20.

10. The resin composition according to claim 4, wherein the resin containing the structure represented by the general formula (1) as a repeating unit has a terminal structure including at least one structure selected from structures represented by general formulae (7), (8), and (9) shown below: 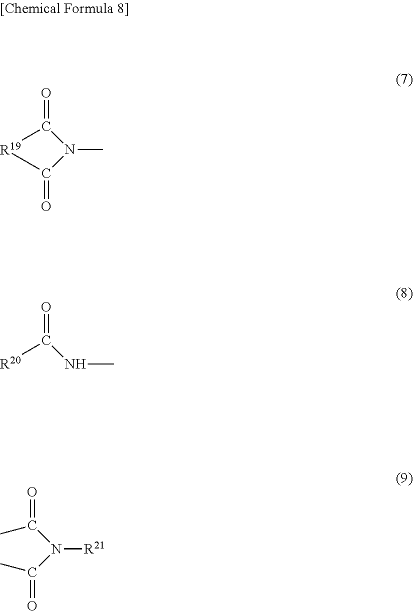
wherein R¹⁹, R²⁰, and R²¹ each independently represent a monovalent organic group having 4 to 30 carbon atoms, and include at least one of a phenolic hydroxyl group, a carboxyl group, and a sulfonic acid group.

11. The resin composition according to claim 1, having a content of the basic compound (b) of 20 to 450 mol % based on 100 mol % of the acidic functional group of the resin (a).

12. The resin composition according to claim 1, wherein the basic compound (b) contains at least one element selected from alkali metals.

13. The resin composition according to claim 3, wherein the water (c) accounts for 80 mass % or more of a solvent contained in the resin composition.

14. The resin composition according to claim 1, further comprising (d) a filler.

15. The resin composition according to claim 14, wherein the filler (d) contains an atom of at least one element among carbon, manganese, aluminum, barium, cobalt, nickel, iron, silicon, titanium, tin, and germanium.

16. The resin composition according to claim 14, wherein the filler (d) contains at least one of silicon, silicon oxide, lithium titanate, silicon carbide, a mixture of two or more of the materials, a mixture containing one of the materials or a mixture of two or more of the materials and carbon, and a product containing one of the materials or a mixture of two or more of the materials and having a carbon-coated surface.

17. A laminate comprising:
a base material; and
a layer formed from the resin composition according to claim 1 on at least one surface of the base material.

18. A method for manufacturing a laminate, the method comprising the steps of:
applying the resin composition according to claim 1 to one or two surfaces of a base material to form a coating film; and
drying the coating film.

19. An electrode comprising the laminate according to claim 17.

20. A secondary battery comprising the electrode according to claim 19.

21. An electric double layer capacitor comprising the electrode according to claim 19.
